(19) United States
(12) Patent Application Publication
(10) Pub. No.: US 2017/0076576 A1
(43) Pub. Date: Mar. 16, 2017

(54) ACTIVITY MONITORING METHOD AND SYSTEM

(71) Applicant: SEOW LOONG TAN, Singapore (SG)

(72) Inventor: SEOW LOONG TAN, Singapore (SG)

(21) Appl. No.: 15/308,949

(22) PCT Filed: May 1, 2015
(86) PCT No.: PCT/SG2015/050093

§ 371 Date: Nov. 4, 2016

(30) Foreign Application Priority Data
May 4, 2014 (SG) 10201402026R

(51) Int. Cl. G08B 21/04; G06K 9/00

(52) U.S. Cl. CPC G08B 21/0423; G06K 9/00771; G08B 21/0476; G08B 21/0492

(57) ABSTRACT

Human activity monitoring systems are mainly used for tracking and monitoring of activities of people. Constant monitoring is required in order to ensure that proper care is provided for each person when faced with events such as sudden health issues and the like emergencies. Existing systems require constant monitoring and are non-adaptive to constant habitual changes or peculiarities of an individual. Described herein is an activity monitoring method that generates activity data from the activities of a person within a defined area before analyzing the activity data to identify presence of anomaly therein based on recognizing deviation of the activity data from activity profile. The activity profile is indicative of the expected activity and behavior of the person

### TECHNICAL FIELD

This invention relates generally to a method and a system for monitoring activities in defined areas.

### BACKGROUND

Human activity monitoring systems are mainly used for tracking and monitoring of activities of a human. An example of application of such systems is in the tracking and monitoring of elderly people with different types of disabilities and health issues. Constant monitoring is required in order to ensure that proper care is provided for each elder and to minimize the response time in an event where an elderly person faces sudden health issues such as heart attacks, seizures and the like emergencies.

U.S. Pat. No. 8,075,499 B2 describes a method for monitoring seizures. In this system, the monitoring element is a wearable, non-intrusive, passive monitoring device that does not require any insertion or ingestion into the human body. However, there is a need to constantly keep the monitoring element worn with limited applications to monitoring of seizures.

United States Patent Application document 20130128022 A1 describes an intelligent motion capture element that includes sensor personalities that optimize the sensor for specific movements and/or pieces of equipment and/or clothing and may be retrofitted onto existing equipment. The system allows interchanging, through automatic detection, between personalities. However, the system non-adaptive to constant habitual changes or peculiarities and therefore requires the personalities to be accurately identified from the outset. Therefore, there exists a need for an easily implementable and substantially adaptive system and method for activity monitoring.

### SUMMARY

In accordance with an aspect of the invention, there is disclosed an activity monitoring method comprising sensing activity of a person within a defined area using a plurality of sensors to generate activity data therefrom. The activity monitoring method further comprising analyzing the activity data to identify presence of anomaly therein, and triggering an alert upon detecting an anomaly in the activity data, the anomaly being detectable by recognizing deviation of the activity data from activity profile, the activity profile being indicative of the expected activity and behavior of the person.

In accordance with a second aspect of the invention, there is disclosed an activity monitoring method comprising sensing activity of a plurality of persons in a plurality of defined areas using a plurality of sensors to generate activity data for each of the plurality of persons therefrom. The activity monitoring method further comprising analyzing the activity data of each of the plurality of persons to identify presence of anomaly therein, and triggering an alert upon detecting an anomaly in the activity data of an identified one of the plurality of persons in an identified one of the plurality of defined areas, the anomaly being detectable by recognizing deviation of the activity data from activity profile associated with at least one of the identified one of the plurality of persons and the identified one of the plurality of defined areas where the anomaly was detected, the activity profile being indicative of the expected activity and behavior of the person.

In accordance with a third aspect of the invention, there is disclosed an activity monitoring system comprising a plurality of sensors, a controller system and at least one image capture device. The plurality of sensors for sensing activity of a person within a defined area to generate activity data therefrom and the controller system for analyzing the activity data to identify presence of anomaly therein, the controller further for triggering an alert upon detecting an anomaly in the activity data, the anomaly being detectable by recognizing deviation of the activity data from activity profile, the activity profile being indicative of the expected activity and behavior of the person.

### BRIEF DESCRIPTION OF THE DRAWINGS

FIG. 1 shows a system diagram of an activity monitoring system in accordance with an aspect of the invention; and

FIG. 2 shows a process flow diagram of an activity monitoring method according to an aspect of the invention and utilized by the activity monitoring system of FIG. 1.

### DETAILED DESCRIPTION

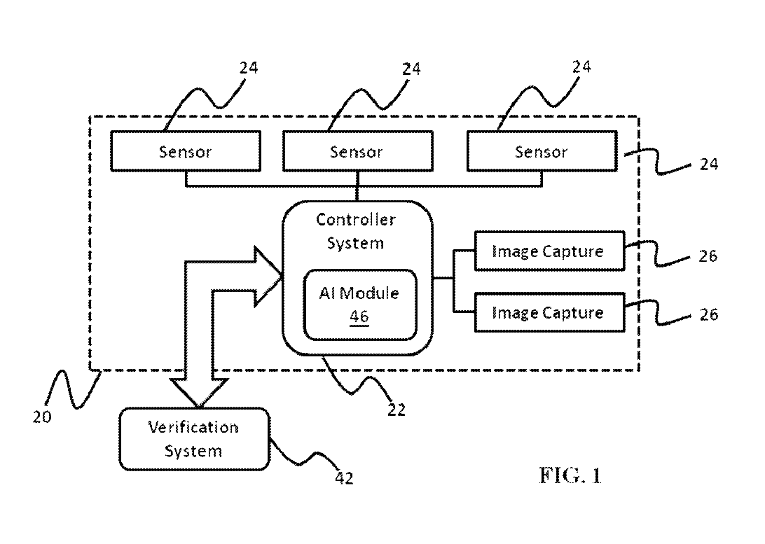

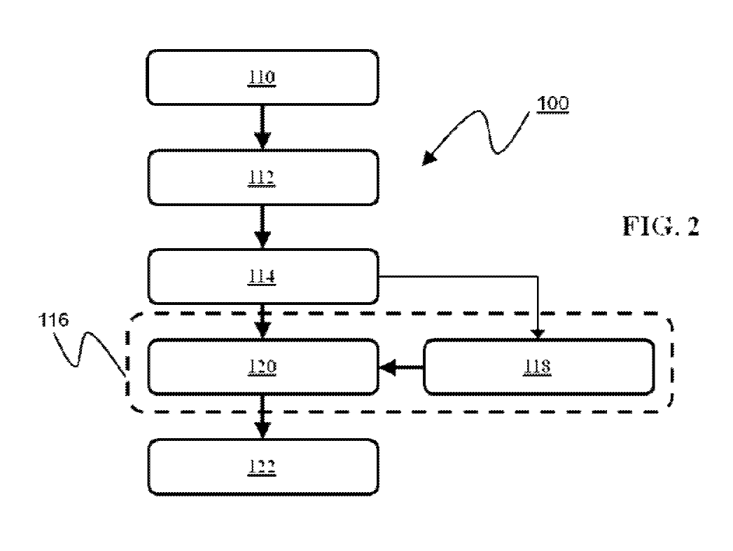

An exemplary embodiment of the present invention, an activity monitoring system 20 utilising an activity monitoring method 100, is described hereinafter with reference to FIG. 1 and FIG. 2. The activity monitoring system 20 comprises a controller system 22, a plurality of sensors 24 and a plurality of image capture devices 26. The plurality of sensors 24 and the plurality of image capture devices 26 are in signal and data communication with the controller system 22. The plurality of sensors 24 are for sensing one or more parameters. For example, each of the plurality of sensors 24 can be one of a motion sensor, a light sensor and a temperature sensor. It is preferred that at least one of the plurality of sensors 24 is a motion sensor. The plurality of sensors 24 are preferably arranged for detection and sensing coverage of one or more defined areas. It is preferred that the plurality of sensors 24 are wireless electronic sensors that are wirelessly linked to the control system 22.

In an implementation of the activity monitoring system 20, the activity monitoring method 100 initiates with sensing activity of a person within a defined area in a step 110 using the plurality of sensors 24 to generate activity data therefrom. The activity data includes detected movement and presence or absence of the person within the defined area, preferably along a timeline. The activity data can further include the temperature and lighting level or other values that are indicative of the environmental conditions within the defined area. In addition, the activity data can further include movement specific data, for example from accelerometer arrays, and observation-based data from facial recognition systems or thermal profiling systems.

Next, the activity data is analysed in a step 112 to identify presence of activity anomaly. The activity anomaly can include the absence of movement from the person at a particular time of day, or day of the week, where movement is to be expected. The activity data is analysed in the step 112 by comparing the activity data with activity profile.

The person being monitored could be an elderly person with certain disabilities. Based on the nature of the disabilities or the monitoring strategy, sensing of the activity of the person in the step 110 can be performed continuously or periodically. Periodic sensing of the activity of the person is preferably performed based upon a sensing schedule that is predefined. The sensing schedule being generated from expected activity variations and corresponding expected activities derived from the activity profile. Even when periodic sensing is employed in the step 110, the controller system 22 will switch from periodic to continuous sensing of activity of the person upon non-occurrence of at least one of the expected activities.

Next in a step 114, deviation of the activity data from the activity profile is recognized or identified by the controller system 22 to thereby detect activity anomaly. The activity profile comprises reference data with recency, intensity and frequency dimension parameters with corresponding event-based weightages that are indicative of activity, behaviour and habits of the person. The reference data is further categorized to indicate activity, behaviour and habits that are typical, as well as specific to the time of day, day of the month and year, location of the person and other additional observations and peculiarities activity, behaviour and habits of the person. In a step 116, the controller system 22 triggers an alert upon ascertaining that an anomaly in the activity of the person, based on the generated activity data, has been detected. When the alert has been triggered, the controller system 22 will utilize at least one of the plurality of image capture devices 26 to capture at least one image of at least a portion of the defined area in a step 118. The at least one image capture device 26 is positioned for capturing images of predetermined portions of the defined area. The at least one image capture device 26 is one of a closed-circuit image capture device, a CMOS-type image capture device or the like image capture apparatus.

In the step 118, the person is associated with the captured at least one image by associating identity data of the person with the captured at least one image. The person is identifiable by identity data associated therewith. The identity data can include one or more of the name, age, medical and physical conditions, location and emergency information of the person associated therewith.

In a step 120, the captured at least one image is sent together with the associated identity data for sending to a verification system 42. The verification system 42 can be a desktop computer, a server with an attached user interface, a notebook, mobile device or the like systems for a user of the verification system 42 to view the at least one image and verify or validate the activity anomaly associated with the person.

Upon viewing the at least one image, the user of the verification system 42 may verify that the activity anomaly is cause for concern and will go on to inform the relevant institutions, person(s), authorities or activate emergency services to look into the matter or tend to the person. For example, the at least one image may show the person lying on the floor or in an awkward position which requires medical assistance to be activated. Conversely, the user may determine that it is a false alarm based on the at least one image.

Regardless of outcome from the step 120, the outcome has to be captured by the verification system 40 for sending back to the controller system 22. In a step 122, it is preferred that the controller system 22 comprise an artificial intelligence (AI) module 46 for capturing the outcome received from the verification system 42 in the step 120 for updating the activity profile so that the activity monitoring system 20 may learn from each event and be more adaptive to varying situations in the future.

Even when an activity anomaly has not been captured or identified by the controller system 22, the user of the verification system 42 or an administrator of the controller system 22 may interface therewith to inform the controller system 22 that a particular event has occurred on a particular date at a particular time so that the activity profile can be updated by the AI system 46 to reduce occurrence of non-detection of activity anomaly in the future.

The controller system 22, in particular the AI module 46, may employ statistical confidence levels and threshold parameters to improve the accuracy of detecting activity anomalies. Therefore, the step 114 may further comprise recognizing deviation of the activity data from the activity profile beyond allowable limits defined by threshold parameters associated with the activity profile. Further, the step 122 may also involve updating of specific threshold parameters associated with the activity profile of the person.

If the person being monitored is an elderly person with certain disabilities, the controller system 22 learns the typical behavior of each elderly in their homes, including sleeping patterns, bathroom visits, normal inactivity interval, duration to stay in one area, the number of times the leave home, and complex sequential patterns. Normal routines can be characterised by time, interval and the sequence of activities that are frequent and predictable. A probabilistic framework to generalized frequent activities observed in the data. The final model can then be used to detect and unusual or abnormal behaviors or the like anomalies.

The activity monitoring system 20 and the activity monitoring method 100 is implementable to premises where there is more than one defined area. For example, there can be a plurality of defined areas extending across a compound or a building with each of the plurality of defined areas representing one residential or commercial unit within the building. Alternatively or in addition, each unit, for example a residential unit, may be demarcated by the plurality of defined areas each representing different living area within the residential unit.

When a plurality of defined areas exist, each thereof will have a unique area identifier to enable identification thereof from provided data. Further, deployment of the plurality of sensors 24 and the plurality of image capture devices 26 need to be sufficiently extensive to cover each and every of the plurality of defined areas. As such, the activity profile and the activity data associated with a particular person will have an additional area identifier parameter therein to represent and capture the additional data dimension.

Additionally or alternatively, each of the plurality of defined areas can have its own activity profile associated therewith. The plurality of sensors 24 will then be further employed to sense activity in each of or selected one or more of the plurality of areas for generating activity data for each of the plurality of areas. The activity profile will define a profile of expected activities at different times of days on different days for each of the plurality of areas. For example, on days when prolonged activities are not expected in certain one or more of the plurality of areas, an alert can be sent to the verification system 42 to enable the user to decide if there is any cause for concern. Further, sudden temperature changes may be detected by the respective plurality of sensors 50 which may result in the control system 22 alerting the fire department or relevant individuals in close proximity

Further, the activity monitoring system 20 and the activity monitoring method can be employed for monitoring the activities of a plurality of persons. The plurality of persons may be monitored within a single defined area or across multiple defined areas. Physical tags may be worn by the plurality or persons to enable discrete identification of the persons being tracked. However, the use of physical tags is not essential to the operation of the activity monitoring system 20 and the activity monitoring method 100. Other forms on tagging can still be employed. For example, the use of the plurality of image capture devices 26 with image processing and/or the use of the plurality of sensors 24 with physical characteristic sensing and identification can be used to identify specific persons so that activity data can be generated for each of the plurality of persons. Each of the plurality of persons will then have a unique identity data associated therewith for tagging to the activity data and images captured by the plurality of image capture devices 26 when employing the steps of the activity monitoring method 100.

The controller system 22 can comprise a single physical on-location system or multiple sub-systems that are entirely on-location or a mix of on-location and cloud-based sub-systems. When employing cloud-based sub-systems, it is preferred that the AI module reside on the cloud so that the “learning” process and the updating of the activity profile are collated and occurs off-location. For multiple location implementation of the activity monitoring system 20 and the activity monitoring method 100 requiring the plurality of defined areas to be employed, it is preferred that the control system 22 further comprises a plurality of control sub-modules 70, with each of the plurality of control sub-modules 70 being assigned to and/or located at one of the plurality of defined areas. Each of the plurality of control sub-modules will be responsible for executing the activity sensing, activity data analyzing, deviation recognition, alert triggering and image capture steps (Steps 112 to 118) of the activity monitoring method 100. Step 120 of sending the captured images to the verification system 42 may be performed by the relevant one of the plurality of control sub-modules 70 or by the AI module 46 residing on-cloud. Step 122 of updating the relevant activity profile will then be performed by the AI module 46. Although the AI module is preferably integrated with the cloud-based sub-system, the on-site control sub-modules 70 will also have the ability to perform the computations and analysis locally similar to the AI module 46 in the cloud-based sub-system.

The control system 22 can employ more than one of the verification system 42 with the relevant one or more of the verification to be alerted in step 120 being determined by the person and/or location to which the alert is associated.

Some of the attributes and further features of the activity monitoring system 20 utilising the activity monitoring method 100 is described hereinafter. The activity monitoring system 20 utilising the activity monitoring method 100 incorporates big data analysis, Internet of Things (IoT), intelligent electronic sensor technology, cloud computing, computer networking and communication technology to monitor and track the activity of a human.

One feature of the activity monitoring system 20 utilising the activity monitoring method 100 is the image capturing capabilities using a camera system. The camera system is only activated when a wireless electronics sensor system of the activity monitoring system detects an abnormal behavior, in order to minimize privacy intrusions. When an abnormal behavior is detected, the camera system will capture images of the person being monitored and send the captured image to an intelligent processor situated locally on-site. The intelligent processor then collates the images together with the relevant data (personal particulars of the respective person, location, etc.) and sends the alert notification to a cloud computing system. The images sent in the alert notification are used for validation and further verification of the person being monitored.

Another feature of the activity monitoring system 20 utilising the activity monitoring method 100 is the integration of the cloud computing with artificial intelligence (AI). When the data is sent to the cloud computing system, the AI system analyzes the data and sends the alert notification to a relevant external party's mobile device. The AI system not only determines the respective external party which the notification is to be sent, but also trains the system from the data received to build a profile for each person or each location of a building which is monitored by the system. Other attributes such as, which particular person must be monitored closely, what are the sleeping patterns, the amount of activities taking place in a certain room of the building, and the activities which takes place inside premises, can be identified by the AI system. This particular feature increases the accuracy of the system and reduces the time to manually enter the data for each person monitored by the system, to the system database. Further, because the AI system is incorporated to the cloud computing system, there is no need to locally integrate the AI system to each site's intelligent processor. This, in turn, makes implementation of the activity monitoring system 20 utilising the activity monitoring method 100 cost effective. Due to the fact that the AI is integrated to the cloud computing system, the activity monitoring system 20 utilising the activity monitoring method 100 can be deployed in a smaller or larger scale. This highlights the scalability of the invention. Also the maintenance of the AI system is convenient, as the invention enables over-the-air-programming (OTA) capabilities.

An attribute of the activity monitoring system 20 utilising the activity monitoring method 100 is the mode transformation from “monitoring mode” to “surveillance” mode. The normal operating mode of the system is the “monitoring mode”. When the system doesn't detect any movement from the wireless sensors for a certain period of time, the on-site intelligent controller will automatically switch the “monitoring mode” to “surveillance mode”. The mode switching can be performed both manually by the user via the intelligent controller or automatically as mentioned. In the “surveillance mode”, the camera will be turned “ON” continuously regardless of whether anomaly is detected by the wireless sensors. A notification is sent to the user's mobile communication device based application with the notification including the images captured by the system's camera. When the application determines that the notification is sent to the device when the system is in the “surveillance mode”, the application will provide the user with the option to inspect the images received and to determine whether to forward the notification to the law enforcement authorities which is nearest to the anomaly location.

The activity monitoring method 100 can be further implemented in the form of a set of computer readable media storing program instructions that when executed cause an automated system having a processing unit, a memory, a plurality of sensors and a controller system: sense activity of a person within a defined area using the plurality of sensors to generate activity data therefrom; and analyze the activity data using the controller system to identify presence of anomaly therein, the controller further for triggering an alert upon detecting an anomaly in the activity data, the anomaly being detectable by recognizing deviation of the activity data from activity profile, the activity profile being indicative of the expected activity and behavior of the person.

Aspects of particular embodiments of the present disclosure address at least one aspect, problem, limitation, and/or disadvantage associated with existing activity monitoring methods and systems. While features, aspects, and/or advantages associated with certain embodiments have been described in the disclosure, other embodiments may also exhibit such features, aspects, and/or advantages, and not all embodiments need necessarily exhibit such features, aspects, and/or advantages to fall within the scope of the disclosure. It will be appreciated by a person of ordinary skill in the art that several of the above-disclosed structures, components, or alternatives thereof, can be desirably combined into alternative structures, components, and/or applications. In addition, various modifications, alterations, and/or improvements may be made to various embodiments that are disclosed by a person of ordinary skill in the art within the scope of the present disclosure, which is limited only by the following claims.

1. An activity monitoring method comprising:
sensing activity of a person within a defined area using a plurality of sensors to generate activity data therefrom;
analyzing the activity data to identify presence of anomaly therein; and
triggering an alert upon detecting an anomaly in the activity data, the anomaly being detectable by recognizing deviation of the activity data from activity profile, the activity profile being indicative of the expected activity and behavior of the person.

2. The activity monitoring method as in claim 1, triggering the alert comprising at least one of:
capturing at least one image of at least a portion of the defined area where the anomaly was detected and associating the person with the captured at least one image; and
sending the captured at least one image to a verification system for verification of the anomaly by a user of the verification system.

3. The activity monitoring method as in claim 1, sensing activity of a person within a defined area comprising:
capturing movement habits of the person within the defined area over a defined duration.

4. The activity monitoring method as in claim 1, sensing activity of a person within a defined area comprising:
periodically sensing activity of the person within the defined area based on a sensing schedule, the sensing schedule being generated from expected activity variations and corresponding expected activities derived from the activity profile.

5. The activity monitoring method as in claim 3, sensing activity of a person within a defined area further comprising:
switching from periodic to continuous sensing of activity of the person upon non-occurrence of at least one of the expected activities.

6. The activity monitoring method as in claim 1, each of the plurality of sensors being one of a motion sensor, a light sensor and a temperature sensor.

7. The activity monitoring method as in claim 1, analyzing the activity data to identify presence of anomaly therein comprising:
comparing the activity data with the activity profile.

8. The activity monitoring method as in claim 2, the person being identifiable by identity data associated therewith and sending the captured at least one image to the verification system comprising sending the captured at least one image with the associated identity data to the verification system for verification of the anomaly by the user of the verification system.

9. The activity monitoring method as in claim 8, associating the person with the captured at least one image comprising:
associating the identity data of the person with the captured at least one image.

10. The activity monitoring method as in claim 9, further comprising:
updating the activity profile based on verification of the anomaly by the user of the verification system.

11. The activity monitoring method as in claim 9, wherein recognizing deviation of the activity data from the activity profile comprising:
recognizing deviation of the activity data from the activity profile beyond allowable limits, the allowable limits being defined by threshold parameters associated with the activity profile.

12. The activity monitoring method as in claim 11, further comprising:
updating at least one of the activity profile and the threshold parameters based on verification of the anomaly by the user of the verification system.

13. An activity monitoring method comprising:
sensing activity of a plurality of persons in a plurality of defined areas using a plurality of sensors to generate activity data for each of the plurality of persons therefrom;
analyzing the activity data of each of the plurality of persons to identify presence of anomaly therein; and
triggering an alert upon detecting an anomaly in the activity data of an identified one of the plurality of persons in an identified one of the plurality of defined areas, the anomaly being detectable by recognizing deviation of the activity data from activity profile associated with at least one of the identified one of the plurality of persons and the identified one of the plurality of defined areas where the anomaly was detected, the activity profile being indicative of the expected activity and behavior of the person.

14. The activity monitoring method as in claim 13, triggering the alert comprising at least one of:
capturing at least one image of at least a portion of the identified one of the plurality of defined areas where the anomaly was detected and associating the identified one of the plurality of persons with the captured at least one image; and
sending the captured at least one image to a verification system for verification of the anomaly by a user thereof.

15. The activity monitoring method as in claim 13, sensing activity of a plurality of persons in a plurality of defined areas comprising:
periodically sensing activity of a plurality of persons in a plurality of defined areas based on a sensing schedule, the sensing schedule being generated from expected activity variations and corresponding expected activities derived from the activity profile; and
switching from periodic to continuous sensing of activity of at least one of the plurality of persons in the plurality of defined areas upon non-occurrence of at least one of the expected activities.

16. The activity monitoring method as in claim 1, each of the plurality of sensors being one of a motion sensor, a light sensor and a temperature sensor.

17. The activity monitoring method as in claim 13, associating the identified one of the plurality of persons with the captured at least one image comprising:
associating identity data of the identified one of the plurality of persons with the captured at least one image, the identified one of the plurality of persons being identifiable by identity data associated therewith

18. The activity monitoring method as in claim 17, triggering an alert upon detecting an anomaly in the activity data further comprising:
identifying one of a plurality of verification systems associated with one of the identified one of the plurality of persons and the identified one of the plurality of defined areas; and
sending the captured at least one image with the associated identity data to the identified one of the plurality of verification systems for verification of the anomaly by a user thereof.

19. The activity monitoring method as in claim 17, further comprising:
updating the activity profile based on verification of the anomaly by the user of the identified one of the plurality of verification systems.

20. An activity monitoring system comprising:
a plurality of sensors for sensing activity of a person within a defined area to generate activity data therefrom;
a controller system for analyzing the activity data to identify presence of anomaly therein, the controller further for triggering an alert upon detecting an anomaly in the activity data, the anomaly being detectable by recognizing deviation of the activity data from activity profile, the activity profile being indicative of the expected activity and behavior of the person.

21. The activity monitoring system as in claim 20, further comprising:
at least one image capture device for capturing at least one image of at least a portion of the defined area where the anomaly was detected and associating the person with the captured at least one image upon the alert being triggered by the controller,
wherein the plurality of sensors and the at least one image capture device are in signal communication with the controller.

22. The activity monitoring system as in claim 20, the controller system comprising:
an artificial intelligence system, the captured at least one image being sent with an associated identity data to a verification system for verification of the anomaly by a user of the verification system, the artificial intelligence system updating the activity profile based on verification of the anomaly by the user of the verification system,
wherein the person being identifiable by the identity data associated therewith.
